(19) United States
(12) Patent Application Publication
(10) Pub. No.: US 2024/0340801 A1
(43) Pub. Date: Oct. 10, 2024

(54) Wireless Communication Device Power Conservation

(71) Applicant: Telefonaktiebolaget LM Ericsson (publ), Stockholm (SE)

(72) Inventors: Olof Liberg, Enskede (SE); Tuomas Tirronen, Helsinki (FI); Andreas Höglund, Solna (SE)

(21) Appl. No.: 18/579,399

(22) PCT Filed: Jul. 15, 2022
(86) PCT No.: PCT/SE2022/050714

§ 371 Date: Jan. 15, 2024

Related U.S. Application Data
(60) Provisional application No. 63/222,949, filed on Jul. 16, 2021.

(51) Int. Cl. H04W 52/02; H04W 60/04; H04W 68/02; H04W 76/28

(52) U.S. Cl. CPC H04W 52/0248; H04W 60/04; H04W 68/02; H04W 76/28

(57) ABSTRACT

A wireless communication device (12) is configured for use in a wireless communication network (10). The wireless communication device (10) switches from a first state (S1), in which wireless communication equipment (16) of the wireless communication device (12) keeps track of time, to a second state (S2) in which the wireless communication equipment (16) does not keep track of time. Before or as part of switching from the first state (S1) to the second state (S2). the wireless communication device (12) obtains a time reference (22). While in the second state (S2), the wireless communication device (12) stores the time reference (22) in memory (24). After or as part of switching from the second state (S2) to the first state (S1), the wireless communication device (12) resumes track of time using the time reference (22).

### TECHNICAL FIELD

The present application relates generally to a wireless communication device and relates more particularly to wireless communication device power conservation.

### BACKGROUND

A wireless communication device consumes meaningful power in order to receive wireless communication service from a wireless communication network. The radio frequency module, for example, must consume power in order to transmit and receive radio signals. During periods of inactivity, when there is nothing to be transmitted or received, a wireless communication device can conserve power and prolong battery life by entering into a power conservation state.

For example, according to known approaches applicable for Internet of Things (IoT) devices, a wireless communication device's radio frequency module may enter into a Power Saving Mode (PSM) e.g., as specified in 3GPP TS 24.301 Release 12. In the PSM, the radio frequency module minimizes its power consumption so that it is even lower than the power consumption during normal idle state, e.g., Radio Resource Control, RRC, idle state. The radio frequency module in this regard powers down a portion of its hardware components for a period of time. The radio frequency module exploits timer(s) that remain powered during PSM in order to trigger the radio frequency module to exit PSM, e.g., to provide a tracking area update to the network.

Despite the meaningful power conservation provided by PSM and other types of power conservation states, a need remains for improving a wireless communication device's power consumption, especially with the proliferation of IoT devices and Reduced Capability (RedCap) devices.

### SUMMARY

Embodiments herein introduce a new power conservation state for wireless communication equipment (e.g., a radio frequency module) of a wireless communication device. In this state, the wireless communication equipment does not even keep track of time (e.g., no timers run) and/or the wireless communication equipment powers down all (not just some) of its hardware components (e.g., including its timer(s)). Before entering the new power conservation state, though, the wireless communication equipment in some embodiments obtains a time reference and stores that time reference while in the new state. Then, when exiting the new state, the wireless communication equipment can use that stored time reference to resume track of time. By foregoing the tracking of time and/or powering down all hardware components in the new power conservation state, the wireless communication equipment may advantageously reduce power consumption and prolong battery life as compared to known power conservation approaches.

More particularly, embodiments herein include a method performed by a wireless communication device configured for use in a wireless communication network. The method comprises switching from a first state in which wireless communication equipment of the wireless communication device keeps track of time to a second state in which the wireless communication equipment does not keep track of time. The method also comprises, before or as part of switching from the first state to the second state, obtaining a time reference, and while in the second state, storing the time reference in memory. The method further comprises switching from the second state to the first state, and after or as part of switching from the second state to the first state, resuming track of time using the time reference.

In some embodiments, while in the second state, all hardware components of the wireless communication equipment are powered down and/or no timer of the wireless communication equipment is running.

In some embodiments, the method also comprises while in the first state, keeping track of time using a timer. In this case, the method also comprises, before or as part of switching from the first state to the second state, capturing a state of the timer, and while in the second state, storing in memory also the captured state of the timer. In this case, the method also comprises, after or as part of switching from the second state to the first state, obtaining an updated time reference, and determining an amount of time that passed while in the second state by comparing the updated time reference to the time reference stored in memory. In some embodiments, said resuming comprises resuming keeping track of time using the timer by updating the state of the timer to account for the determined amount of time that passed while in the second state. In some embodiments, the timer tracks time for paging, discontinuous reception, public land mobile network search, tracking area update, or tracking area registration. In some embodiments, while in the first state, the wireless communication equipment keeps track of time using the timer as part of keeping track of when to execute a procedure in the first state. In other embodiments, while in the second state, the wireless communication equipment does not keep track of when to execute the procedure, and resuming keeping track of time is performed as part of the wireless communication equipment resuming keeping track of when to execute the procedure. In some embodiments, resuming keeping track of when to execute the procedure comprises resuming keeping track of when to execute the procedure using the timer, with the state of the timer updated to account for the determined amount of time that passed while in the second state. In some embodiments, the procedure is a paging procedure, a discontinuous reception procedure, a public land mobile network search procedure, a tracking area update procedure, or a tracking area registration procedure. In some embodiments, the method also comprises, after switching from the second state to the first state and after the state of the timer has been updated to account for the determined amount of time that passed while in the second state, executing the procedure. In some embodiments, the procedure is executed when the timer expires. In other embodiments, the procedure is alternatively executed responsive to determining that the amount of time that passed while in the second state is greater than an amount of time that remained on the timer before switching to the second state. In some embodiments, the method further comprises, before or as part of switching from the first state to the second state, stopping the timer. In some embodiments, the captured state of the timer includes a value of the timer when the timer is stopped, and said resuming comprises offsetting a value of the timer by the determined amount of time that passed while in the second state and re-starting the timer with the adjusted value. In some embodiments, the timer is an idle state timer configured to run in an idle state.

In some embodiments, obtaining the time reference comprises receiving the time reference from a network node in the wireless communication network.

In some embodiments, the method further comprises, while in the first state, keeping track of time using a timer, and, before or as part of switching from the first state to the second state, stopping the timer. In some embodiments, the time reference obtained and stored in memory is a value of the timer when the timer is stopped. In some embodiments, said resuming comprises resuming keeping track of time using the timer by re-starting the timer with the value stored in memory.

In some embodiments, the first state is a Radio Resource Control, RRC, idle state, a power-saving mode, or a Mobile Initiated Communication Only, MICO, mode.

In some embodiments, the second state is a zero power idle state.

In some embodiments, the wireless communication device comprises control equipment configured to control said switching from the second state to the first state. In some embodiments, the control equipment monitors an amount of energy harvested while in the second state and controls switching from the second state to the first state to occur when the amount of energy harvested reaches a threshold amount. In other embodiments, the control equipment alternatively monitors an amount of time passed while in the second state and controls switching from the second state to the first state to occur when the amount of time passed reaches a threshold amount. In some embodiments, while in the first state, the control equipment is powered and at least one hardware component of the wireless communication equipment is powered. In some embodiments, while in the second state, the control equipment is powered and all hardware components of the wireless communication equipment are powered down.

In some embodiments, the wireless communication equipment comprises a wireless module. In some embodiments, the wireless module comprises baseband processing circuitry and/or radio frequency front-end circuitry.

In some embodiments, the method further comprises, before or as part of switching from the first state to the second state, transmitting, to a network node in the wireless communication network, signaling. In some embodiments, the signaling indicates that the wireless communication device is or will be unreachable. In other embodiments, the signaling alternatively or additionally indicates that the wireless communication device is or will be in the second state. In this case, the wireless communication device is unreachable in the second state. In yet other embodiments, the signaling alternatively or additionally indicates a time interval for which the wireless communication device will be unreachable.

Other embodiments herein include a method performed by a network node of a wireless communication network. The method comprises receiving, from a wireless communication device, signaling. In some embodiments, the signaling indicates that the wireless communication device is or will be unreachable. In other embodiments, the signaling alternatively or additionally indicates that the wireless communication device is or will be in a certain state. In this case, the wireless communication device is unreachable in the certain state. In yet other embodiments, the signaling alternatively or additionally indicates a time interval for which the wireless communication device will be unreachable.

In some embodiments, the signaling indicates that the wireless communication device is or will be in the certain state, wherein the certain state is a zero power idle state.

In some embodiments, the method further comprises handling paging of the wireless communication device, and/or downlink data for the wireless communication device, based on receiving the signaling. In some embodiments, said handling comprises, based on the received signaling, suspending paging of the wireless communication device. In other embodiments, said handling alternatively comprises, based on the received signaling, buffering downlink data for the wireless communication device. In yet other embodiments, said handling alternatively comprises, based on the received signaling, discarding downlink data for the wireless communication device. In still yet other embodiments, said handling alternatively comprises, based on the received signaling, notifying a sender of the downlink data that the wireless communication device is unreachable.

Other embodiments herein include a wireless communication device configured for use in a wireless communication network. The wireless communication device is configured to switch from a first state in which wireless communication equipment of the wireless communication device keeps track of time to a second state in which the wireless communication equipment does not keep track of time. The wireless communication device is also configured to, before or as part of switching from the first state to the second state, obtain a time reference, and while in the second state, store the time reference in memory. The wireless communication device is also configured to, switch from the second state to the first state, and after or as part of switching from the second state to the first state, resume track of time using the time reference.

In some embodiments, the wireless communication device is configured to perform the steps described above for a wireless communication device.

Other embodiments herein include a network node of a wireless communication network. The network node is configured to receive, from a wireless communication device, signaling. In some embodiments, the signaling indicates that the wireless communication device is or will be unreachable. In other embodiments, the signaling alternatively or additionally indicates that the wireless communication device is or will be in a certain state. In this case, the wireless communication device is unreachable in the certain state. In yet other embodiments, the signaling alternatively or additionally indicates a time interval for which the wireless communication device will be unreachable.

In some embodiments, the network node is configured to perform the steps described above for a network node.

Other embodiments herein include a computer program comprising instructions which, when executed by at least one processor of a wireless communication device, causes the wireless communication device to perform the steps described above for a wireless communication device. Other embodiments herein include a computer program comprising instructions which, when executed by at least one processor of a network node, causes the network node to perform the steps described above for a network node. In some embodiments, a carrier containing the computer program is one of an electronic signal, optical signal, radio signal, or computer readable storage medium.

Other embodiments herein include a wireless communication device configured for use in a wireless communication network. The wireless communication device comprises wireless communication equipment and control equipment whereby the wireless communication device is configured to switch from a first state in which the wireless communication equipment keeps track of time to a second state in which the wireless communication equipment does not keep track of time. The wireless communication device is also configured to, before or as part of switching from the first state to the second state, obtain a time reference, and while in the second state, store the time reference in memory. The wireless communication device is also configured to switch from the second state to the first state, and after or as part of switching from the second state to the first state, resume track of time using the time reference.

In some embodiments, the wireless communication equipment comprises a wireless module. In some embodiments, the wireless module comprises baseband processing circuitry and/or radio frequency front-end circuitry.

In some embodiments, the wireless communication equipment is configured to perform the steps described above for a wireless communication equipment.

Other embodiments herein include a network node of a wireless communication network. The network node comprises communication circuitry and processing circuitry. The processing circuitry is configured to receive, from a wireless communication device, via the communication circuitry, signaling. In some embodiments, the signaling indicates that the wireless communication device is or will be unreachable. In other embodiments, the signaling alternatively or additionally indicates that the wireless communication device is or will be in a certain state. In this case, the wireless communication device is unreachable in the certain state. In yet other embodiments, the signaling alternatively or additionally indicates a time interval for which the wireless communication device will be unreachable.

In some embodiments, the processing circuitry is configured to perform the steps described above for a network node.

Embodiments herein further include those enumerated in the Group A, B, X, and C Embodiments sections herein.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1A is a block diagram of a wireless communication device and network node according to some embodiments.

FIG. 1B is a block diagram of operation of a wireless communication device in a second state according to some embodiments.

FIG. 1C is a block diagram of a wireless communication device configured to retrieve a time reference from memory and use that time reference to resume keeping track of time according to some embodiments.

FIG. 1D is a block diagram of a wireless communication device configured to receive an updated time reference from a wireless communication network and use that updated time reference to resume keeping track of time according to some embodiments.

FIG. 2A is a timing diagram of a power-saving mode (PSM) according to some embodiments.

FIG. 2B is a timing diagram of Mobile Initiated Communication Only (MICO) mode according to some embodiments.

FIG. 3 is a logic flow diagram of a method performed by a wireless communication device according to some embodiments.

FIG. 4 is a logic flow diagram of a method performed by a network node according to some embodiments.

FIG. 5 is a logic flow diagram of a method performed by a wireless communication device configured for use in a wireless communication network according to some embodiments.

FIG. 6 is a logic flow diagram of a method performed by wireless communication equipment of a wireless communication device configured for use in a wireless communication network according to some embodiments.

FIG. 7 is a logic flow diagram of a method performed by a network node of a wireless communication network according to some embodiments.

FIG. 8 is a block diagram of a wireless communication device according to some embodiments.

FIG. 9 is a block diagram of a network node according to some embodiments.

FIG. 10 is a block diagram of wireless communication equipment according to some embodiments.

FIG. 11 is a block diagram of a communication system in accordance with some embodiments.

FIG. 12 is a block diagram of a user equipment according to some embodiments.

FIG. 13 is a block diagram of a network node according to some embodiments.

FIG. 14 is a block diagram of a host according to some embodiments.

FIG. 15 is a block diagram of a virtualization environment according to some embodiments.

### DETAILED DESCRIPTION

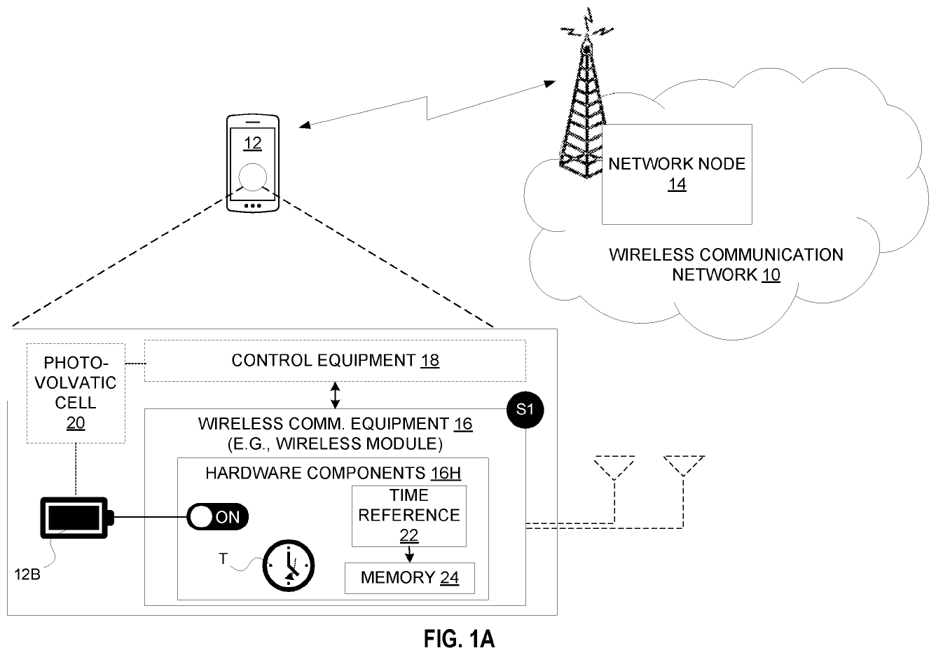

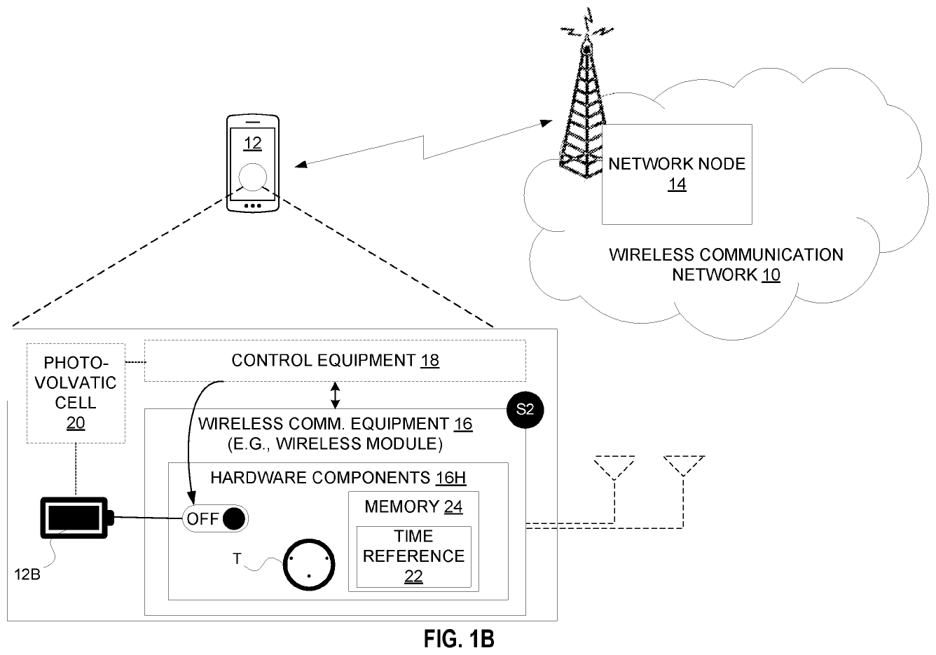

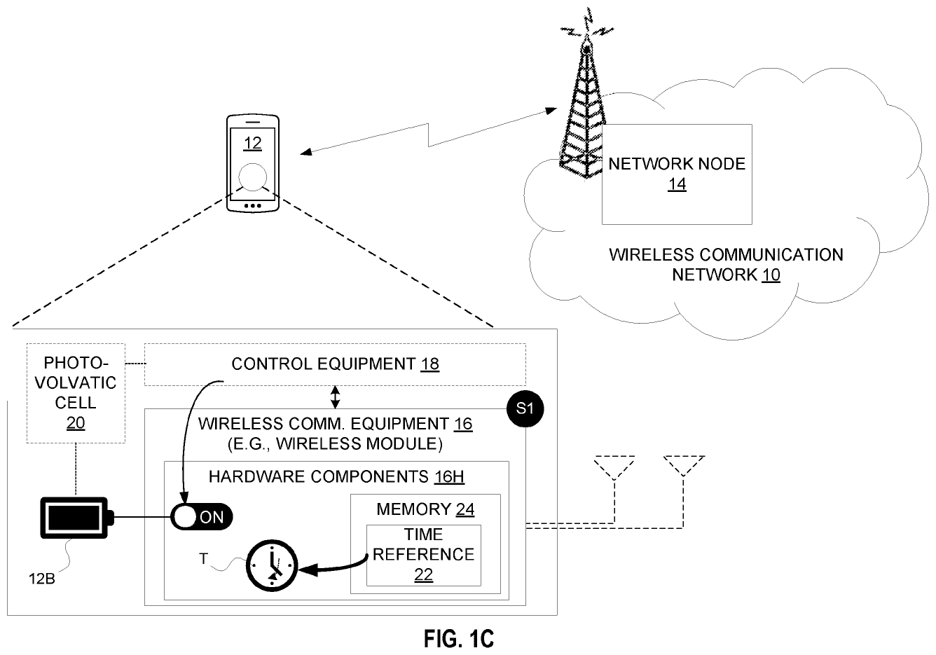

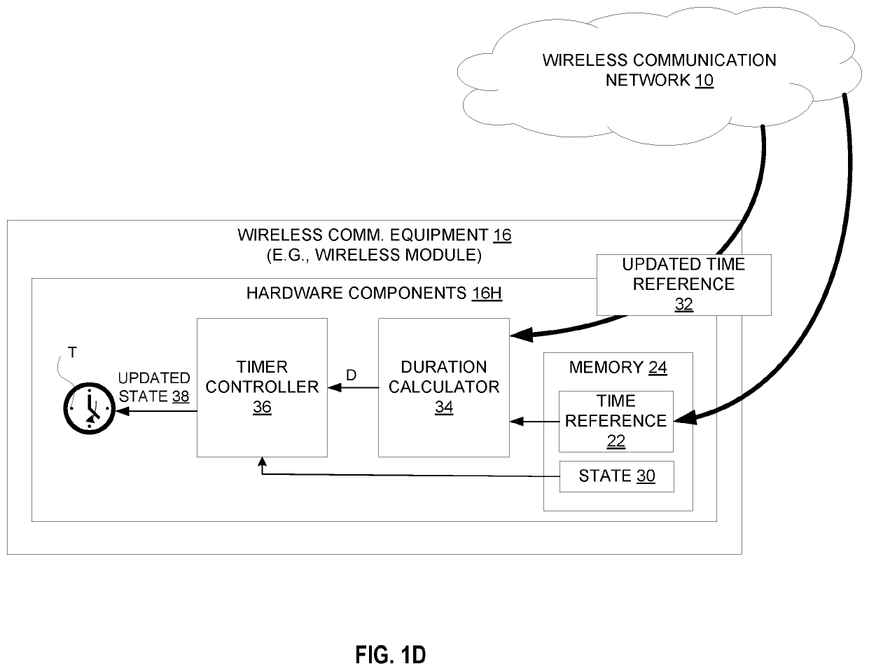

FIG. 1A shows a wireless communication device 12 configured for use in a wireless communication network 10 according to some embodiments. The wireless communication device 12 receives wireless communication service from the wireless communication network 10. The wireless communication device 12 in this regard is configured to transmit and/or receive over a wireless interference with the wireless communication network 10, e.g., as provided via one or more network nodes, one of which is shown as network node 14.

The wireless communication device 12 includes wireless communication (comm.) equipment 16. The wireless communication equipment 16 may for example be or include a wireless module, e.g., configured to perform wireless transmission and reception as specified by the 3^{rd} Generation Partnership Project (3GPP). The wireless module may, for instance, include baseband processing circuitry and/or radio frequency front-end circuitry. The baseband processing circuitry may contain hardware components configured to perform baseband signal processing, e.g., including analog to digital conversion, digital to analog conversion, gain adjustment, modulation/demodulation, channel encoding/decoding, etc. The radio frequency (RF) front-end circuitry may contain hardware components configured to convert received RF signals to baseband signals and convert baseband signals to RF signals for transmission. The RF front-end circuitry's hardware components may for instance include a mixer, a local oscillator (LO), etc. Generally, then, the wireless communication equipment 16 in these and other embodiments includes hardware components 16H, e.g., hardware components of baseband processing circuitry and/or RF front-end circuitry.

The wireless communication device 12 as shown further includes a battery 12B, e.g., for powering the wireless communication equipment 16 and/or other components of the wireless communication device 12.

The wireless communication device 12 in some embodiments may also include control equipment 18. The control equipment 18 controls operation of the wireless communication equipment 16 and/or other components of the wireless communication device 12.

In some embodiments, the wireless communication equipment 16 is operable in any of multiple different possible states. The different states may for example include one or more power conservation states reflecting one or more different extents to which the wireless communication equipment 16 targets power conservation.

More particularly, FIG. 1A shows wireless communication equipment 16 operation in a first state S1. The first state S1 may reflect normal operation, e.g., in a Radio Resource Control (RRC) connected state, may reflect idle operation, e.g., in an RRC idle or inactive state, or may reflect a power conservation state, e.g., Power Saving Mode (PSM) or a Mobile Initiated Communication Only (MICO) state as described more fully later. Regardless, in this first state S1 as shown, at least one of the wireless communication equipment's hardware components 16 is powered. Powering of at least a portion of the wireless communication equipment 16 in this regard may facilitate keeping track of time while in the first state S1. By keeping track of time, the wireless communication equipment 16 in the first state S1 is able to itself keep track of when to trigger execution of a procedure, e.g., so that the wireless communication equipment 16 can trigger execution of the procedure when a defined amount of time has passed. For example, in embodiments where the first state is a power conservation states such as PSM or MICO, the wireless communication equipment 16 may keep track of time in order to keep track of when to exit (e.g., wake up from) that power conservation state. More particularly in this regard, FIG. 1A shows that the hardware components 16 may include a timer T for keeping track of time while in the first state S1. When powered while in the first state S1, the timer T periodically increments or decrements its value with the passage of time, e.g., so that a procedure can be executed when the timer's value reaches a certain value, where that procedure may for instance prompt exiting the first state S1.

FIG. 1B notably shows wireless communication equipment 16 operation in a second state S2 according to some embodiments. This second state S2 may conserve more power than the first state S1. In fact, in one or more embodiments shown, all hardware components 16H of the wireless communication equipment 16 are powered off in the second state S2, e.g., as compared to at least one hardware component 16H still being powered in the first state S1. The second state S2 in some cases therefore may be referred to as a zero power state or a zero power idle state, e.g., suggesting that the wireless communication equipment's power consumption is or is approximately zero in the second state S2. As shown in FIG. 1B, then, even the timer T that kept track of time in the first state S1 is powered off and accordingly does not keep track of time in the second state S2, e.g., in the sense that the timer T does not periodically increment or decrement its value with the passage of time. This may be true also for any other timer(s) of the wireless communication equipment 16, e.g., such that no timer of the wireless communication equipment 16 runs while in the second state S2. In these and other embodiments, therefore, the wireless communication equipment 16 may keep track of time (e.g., via timer T) in the first state S1 but not keep track of time in the second state S2.

Note here that one or more other components of the wireless communication device 12 may still be powered when the device's wireless communication equipment 16 is in the second state S2. The control equipment 18 for example may remain powered, e.g., for controlling one or more aspects of the wireless communication device 12 while the device's wireless communication equipment 16 is in the second state S2. For instance the control equipment 18 may remain powered to control or otherwise facilitate the wireless communication equipment 16 to exit from (e.g., awaken from) the second state S2.

Nonetheless, powering down of the wireless communication equipment's hardware components 16H may enable the wireless communication device 12 to harvest energy. As shown for instance the wireless communication device 12 may include a photo-volvatic cell 20 connected to the battery 12B. The photo-volvatic cell 20 may harvest energy and store that harvested energy in the battery 12B. In these embodiments, the control equipment 18 may control the wireless communication equipment 16 to exit the second state S2 (e.g., as part of switching to the first state S1) when the amount of harvested energy reaches a threshold.

No matter what prompts exit from the second state S2, according to some embodiments, the wireless communication equipment 16 resumes keeping track of time after exiting the second state S2, e.g., after switching from the second state S2 to the first state S1. Towards this end, the wireless communication equipment 16 as shown in FIG. 1A obtains a time reference 22 before or as part of switching from the first state S1 to the second state S2. The time reference 22 may for example take the form of a timestamp (e.g., an absolute timestamp), a timer value, or any other value that serves as a reference for time. Regardless of the time reference's form, the wireless communication equipment 16 stores this time reference 22 in memory 24 while in the second state S2, as shown in FIG. 1B. The memory 24 may for instance be non-volatile memory, e.g., so as to persistently store the time reference 22 even without power being applied to the memory 24 while in the second state S2. Then, after or as part of switching away from the second state S2 (e.g., back to the first state S1), the wireless communication equipment 16 may retrieve the time reference 22 from memory 24 and use that time reference 22 to resume keeping track of time, as shown in FIG. 1C.

For example, in some embodiments shown in FIG. 1D, before or as part of switching to the second state S2, the wireless communication equipment 16 obtains the time reference 22 by receiving that time reference 22 from the wireless communication network 10, e.g., from network node 14 and/or within broadcasted System Information. In these and other embodiments, the wireless communication equipment 16 may thereafter receive an updated time reference 32 from the wireless communication network 10 after or as part of switching away from the second state S2 (e.g., back to the first state S1). The wireless communication equipment 16 may then resume track of time using the time reference 22 stored in memory 24 and using the updated time reference 32.

For example, as shown, the wireless communication equipment 16 (e.g., via duration calculator 34) may determine the duration D of time that passed while in the second state S2 by comparing the updated time reference 32 to the time reference 22 stored in memory 24. The wireless communication equipment 16 can then resume track of time in a way that accounts for how much time passed while in the second state S2.

For example, as shown in FIG. 1D, the wireless communication equipment 16 may capture a state 30 of the timer T before or as part of switching to the second state S2, e.g., including a value of the timer T so that the stored state 30 reflects the last value that the timer T had before switching to the second state S2 in which the timer T is not running. The wireless communication equipment 16 stores this captured state 30 in memory 24 while in the second state S2. Then, the wireless communication equipment 16 (e.g., via timer controller 36) may resume track of time when switching away from the second state S2 by updating the state 30 of the timer T to account for the determined duration D of time that passed while in the second state S2. The wireless communication equipment may then resume track of time using the updated state 38. For example, where the stored state 30 includes a value of the timer T, the wireless communication equipment 16 may offset or otherwise adjust the stored value of time by the duration D of time that passed while in the second state S2. The wireless communication equipment 16 may then re-start the timer T with the timer T set to the offset value.

As a concrete example, the wireless communication equipment 16 may store in memory 24 that the last value that the timer T had before switching to the second state S2 was t=10 s. Upon switching away from the second state S2, the wireless communication equipment 16 calculates that the duration D spent in the second state S2 was 20 s. Accordingly, the wireless communication equipment 16 offsets the stored value t=10 s by the duration D=20 s so as to re-start the timer T with a value of 30 s, so that the timer T reflects the passage of time while in the second sate S2 even though the timer T was not powered or running in the second state S2.

Note that the timer T in these and other embodiments may be any type of timer. For example, the timer T may track time for paging, discontinuous reception (DRX), public land mobile network search, tracking area update, or tracking area registration. In these and other embodiments, while in the first state, the wireless communication equipment 16 may keep track of time using the timer T as part of keeping track of when to execute a procedure in the first state S1, e.g., a paging procedure, a discontinuous reception procedure, a public land mobile network search procedure, a tracking area update procedure, or a tracking area registration procedure. Then, while in the second state S2, the wireless communication equipment 16 does not keep track of when to execute the procedure, e.g., the timer T is not running. The wireless communication equipment 16 then resumes keeping track of time as part of the wireless communication equipment 16 resuming keeping track of when to execute the procedure. Resuming keeping track of when to execute the procedure may for example involve resuming keeping track of when to execute the procedure using the timer T, with the state of the timer T updated to account for the determined amount of time that passed while in the second state S2. The wireless communication equipment 16 may then execute the procedure according to the timer T, e.g., upon the timer T expiring.

In other embodiments, by contrast, the wireless communication equipment 16 does not account for how much time the wireless communication equipment 16 stayed in the second state S2 when resuming track of time. In these embodiments, the timer reference 22 may just memorialize time as tracked before entering the second state S2 so that the wireless communication equipment 16 can resume tracking time from that point when later exiting the second state S2.

For example, while in the first state, the wireless communication equipment 16 may keep track of time using the timer T (which may also be referred to as a clock or an internal clock). Before or as part of switching from the first state S1 to the second state S2, the wireless communication equipment 16 stops the timer T and obtains the time reference 22 in the form of the value of the timer T when the timer T is stopped (e.g., 10 s). With this value stored in memory 24, the wireless communication equipment 16 later resumes track of time by re-starting the timer T with the value stored in memory 24 (e.g., 10 s). The wireless communication equipment 16 may thereby re-start the timer T with the same value that the timer T had when the wireless communication equipment 16 entered the second state S2.

Note that, although the above description framed the first and second states as being states of the wireless communication equipment 16, in other embodiments the first and second states S1, S2 may more generally be said to be first and second states of the wireless communication device 12 as a whole. Still in this case, though, with the wireless communication device 12 in the first state, at least one hardware component 16H of the device's wireless communication equipment 16 is powered and/or the wireless communication equipment 16 keeps track of time. And, with the wireless communication device 12 in the second state S2, all hardware components 16H of the wireless communication equipment 16 are powered off and/or the wireless communication equipment 16 does not keep track of time. Note here that, in some embodiments, other components of the wireless communication device 12 may keep track of time when the wireless communication equipment 16 is in the second state S2, even though the wireless communication equipment 16 itself does not keep track of time while in the second state S2. Note further in this regard that the memory 24 used for storing the time reference 22 in some embodiments may be memory of the wireless communication equipment 16 specifically, as shown, or may be memory of the wireless communication device 12 more generally.

Note, too, that in some embodiments the wireless communication device 12 or more specifically the wireless communication equipment 16 may notify the wireless communication network 10 of an impending switch to the second state S2. For example, in some embodiments, such notification may take the form of signaling indicating that the wireless communication device 12 is or will be unreachable, that the wireless communication device 12 is or will be in the second state S2, where the wireless communication device 12 is unreachable in the second state S2, and/or a time interval for which the wireless communication device 12 will be unreachable. In these and other embodiments, a network node 14 that receives this signaling may handle paging of the wireless communication device 12, and/or downlink data for the wireless communication device 12, based on receiving the signaling.

For example, the network node 14 may suspend paging of the wireless communication device 12 based on the received signaling. Then, the network node 14 may later resume paging of the wireless communication device 12 when the wireless communication device 12 becomes reachable again. Alternatively or additionally, the network node 14 may buffer downlink data for the wireless communication device 12 based on the received signaling. Then, the network node 14 may later transmit the buffered downlink data to the wireless communication device when the wireless communication device 12 becomes reachable again. Alternatively, the network node 14 may discard downlink data for the wireless communication device 12 based on the received signaling and/or notify a sender of the downlink data that the wireless communication device 12 is unreachable.

Consider now an example context for some embodiments herein. Some embodiments are applicable in a 5G system (5GS). This generation's radio access technology is intended to serve use cases such as enhanced mobile broadband (eMBB), ultra-reliable and low latency communication (URLLC) and mMTC. 5G includes the New Radio (NR) access stratum interface and the 5G Core Network (5GC). Some embodiments in this context are applicable to wireless communication devices that take the form of reduced capability NR devices (RedCap). RedCap user equipments (UE) are suitable for a range of use cases, including industrial sensors, video surveillance, and wearables use cases, with requirements on low UE complexity and sometimes also on low UE power consumption. RedCap user equipments (UEs) are required to have lower cost, lower complexity, a longer battery life, and potentially a smaller form factor than legacy NR UEs. Therefore, in Release 17, different complexity reduction features, such as reduced maximum UE bandwidth, reduced minimum number of receiver branches, reduced maximum number of DL MIMO layers, relaxed downlink modulation order, and support of half-duplex FDD operation are specified for RedCap UEs.

Some embodiments facilitate RedCap UEs to operate on harvested energy. Some embodiments may thereby enable energy harvesting UEs to be self-sufficient, green and environmentally friendly, and ideally perform a perpetual operation. The source of the harvested energy may be, for example, vibration, radio waves, indoor office light, etc. many of the sensor use cases operate in environments where it is possible to harvest ambient energy for operation. The harvested ambient energy may be, for example, vibrational energy, photovoltaic energy, thermal-electric generated energy. Some of these considerations are applicable to video surveillance and medical wearable use cases. For example, a video surveillance camera deployed outdoors may harvest solar energy. A medical wearable device may be able to harvest energy through vibration and it may be desirable that the patients do not need to replace battery themselves (i.e., battery lasts between office visits). To support wireless operation using a minimal amount of energy, e.g., harvested and accumulated over time, it is important that the radio protocol procedures specified for the used wireless technology, e.g., LTE, 5G NR or 6G, supports an ultra-low power consumption.

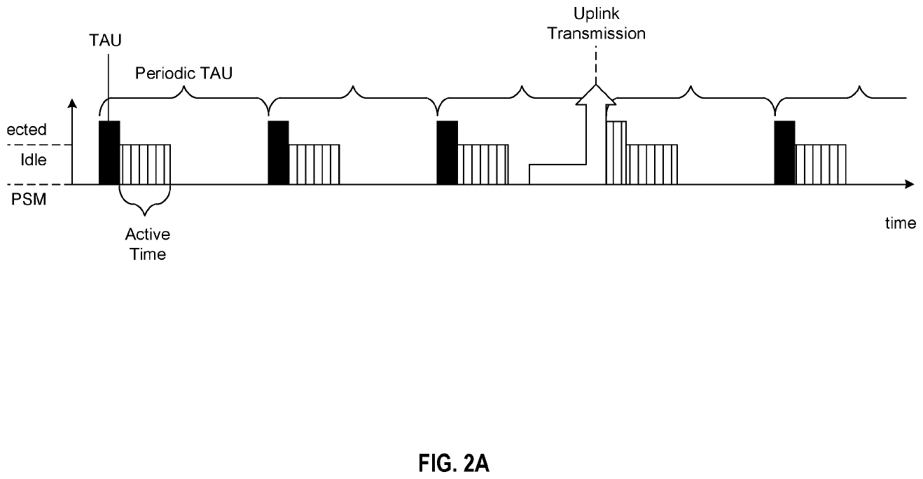

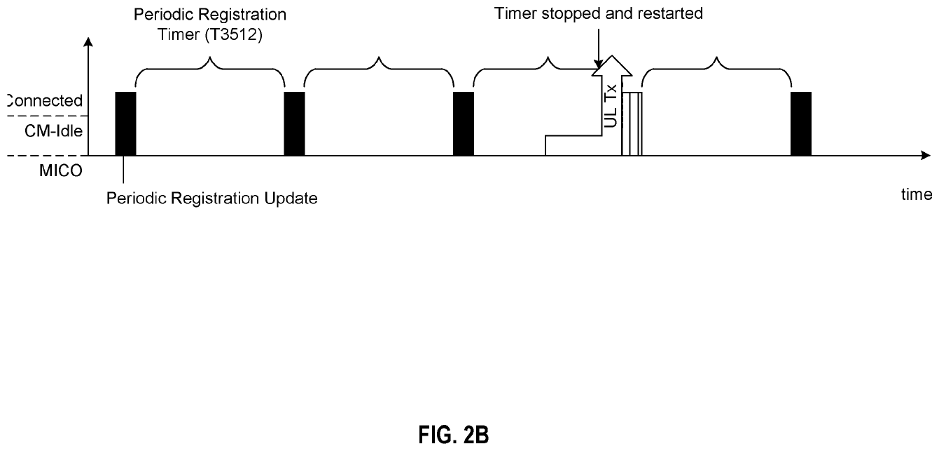

In some embodiments for LTE, the first state S1 herein is a power-saving mode (PSM), e.g., a feature which can provide very long battery life for UEs with infrequent data exchange and no need for quick downlink reachability. PSM works by, for most of the time, keeping the UE in a power efficient sub-state to RRC_IDLE in which all access stratum (AS) functionality is switched off (deep sleep and almost power-off but no re-attach needed). After a connection, the UE will be sent to this power saving state after a certain time in RRC_IDLE mode, controlled by the configurable parameter the active time (T3324), and the UE will return from this state either upon uplink (UL) data transmission or periodic tracking area update (TAU) (T3412). This is illustrated by FIG. 2A. That is, the UE is in sleep state most of the time, but it will be reachable in the downlink by the network either after uplink initiated transmission during a time window (the active time T3324), or periodically with the time interval T3412 of the periodic traffic area update, TAU (i.e., this periodic “keep-alive” uplink control signaling will provide the same time window for downlink reachability even if there are no mobile originated uplink transmissions).

In other embodiments for NR, the first state S1 may be a Mobile Initiated Communication Only (MICO) mode, which is basically the same thing as PSM with some more options. The UE can indicate a preference to use MICO mode during registration, and core network can configure the use of MICO mode by MICO indication information element (IE) (i.e., non-access stratum, NAS, negotiation).

MICO is like PSM but triggered by ‘Periodic registration timer’ (T3512) instead of periodic TAU timer (T3412). T3512 is therefore used for downlink (DL) reachability. The periodic registration timer (T3512) is stopped and restarted when the UE goes to CM-CONNECTED. Also, in MICO the UE will remain reachable after an uplink transmission during a configured time window. MICO is illustrated in FIG. 2B.

Both PSM and MICO may therefore allow a wireless device to power off all hardware modules except for an internal clock keeping track of a timer determining when the device should wake up from its power saving state. The time keeping in the device requires the device to consume power, although limited, even in this first state S1.

To take a final step towards zero power consumption, embodiments herein introduce the second state S2 as a new power efficient idle state where the wireless device is not even required to keep track of time while powered off. Because the wireless device is not even required to keep track of time in this state, the device can consequently power down all of its hardware components. This enables a UE to consume a minimal amount of energy when in a power efficient idle state. This is one step towards allowing a UE to be operated on harvested energy.

More particularly, in a first embodiment, a wireless device state obtains and stores a first time stamp broadcasted by a wireless network node before entering the zero power idle state. This first time stamp exemplifies the time reference 22 discussed above. The time stamp may correspond to an absolute time, e.g., the Coordinated Universal Time (UTC). During the zero power idle state the device powers down and ignores, or suspends, all configured idle mode timers, e.g., for paging, Public Land Mobile Network (PLMN) search and tracking/registration area update (T3412 for PSM, or T3512 for Mico). During the zero power idle state, the UE keeps the first time stamp stored in memory 24 which persists at least the time period the device stays in the zero power idle state. During the zero power idle state, the device also stores relevant idle mode timer configurations, e.g., for paging and DRX, PLMN search and tracking area update/registration. A timer configuration may include a periodicity, and an offset in the period indicating when an event is triggered.

After the device at a later time instance is triggered to leave the zero power idle state (e.g., if a certain amount of energy has been harvested), it obtains a second time stamp broadcasted by a wireless network node. This second time stamp exemplifies the updated time reference 32 discussed above. The second time stamp can be provided for example in broadcast system information.

Alternatively, the second time stamp is included in a signal, such as a wake-up signal, the device obtains and which triggers the device to leave the zero power state. Alternatively, the mentioned signal waveform is made dependent on the second time stamp to implicitly indicate the second time instance. In yet another alternative, the time information is delivered in the signal source the device harvests for energy.

By comparing the first and second time stamps, the wireless device can determine how long time it has spent in the zero power idle state. Based on this knowledge and the stored idle mode timer configurations, the device can resume the timing procedures earlier ignored or suspended, and e.g., receive DL paging, perform PLMN search and tracking area updates at the earlier configured periodicity.

Note that, in PSM and Mico, the purpose of the periodic TAU (using timer T3412) and the periodic registration update (using timer T3512), is to have an infrequent “keep alive” signal from the UE to know it is still active in the network and also where (in which TA or RA). In one embodiment, if the time difference of the first time stamp and the second time stamp is larger than a configurable parameter, e.g., reusing timer T3512, the UE will initiate a registration update procedure (or tracking area update). Compared to the PSM/Mico solution TAU or registration update will be less deterministic, but the procedure is not dependent on predictable timing and will work anyway.

Note that if uplink signaling is initiated by the UE such that a connection with CN signaling is set up, this automatically fills the purpose of TAU or registration update (the network is informed that the UE is still in the network and in which TA or RA it is located).

Note further that the UE will store a new first time stamp every time it enters the zero power idle state, i.e., restarting the zero power idle state procedure with a new time reference.

Although the triggering for the tracking area update or registration update is different from PSM/Mico, the same principle of adding a window for downlink reachability after the tracking area update or registration update could be applied, e.g., reusing the active time T3324.

In one embodiment, a de-registration timer is defined in the network, and at the expiration of which the device will be de-registered in the network.

In another embodiment, the device indicates to the network 10 (NW) that the device will become unreachable before entering the zero power idle state. The NW can use this information to e.g., suspend paging to the UE. In one possible implementation the device additionally indicates the expected or estimated time duration it will be in zero power idle state. The NW may use this information to for example buffer downlink data intended for the device or inform the sender the device is unreachable for a prolonged period of time and alternatively discard the arriving data.

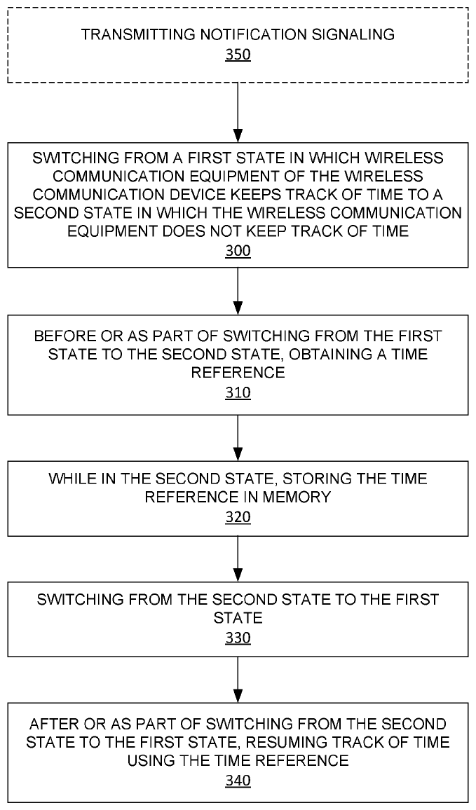

In view of the modifications and variations herein, FIG. 3 depicts a method in accordance with particular embodiments. The method may be performed by the wireless communication equipment 16 specifically or by the wireless communication device 12 generally. The method as shown includes switching from a first state S1 in which wireless communication equipment 16 of the wireless communication device 12 keeps track of time to a second state S2 in which the wireless communication equipment 16 does not keep track of time (Block 300). The method may also comprise, before or as part of switching from the first state S1 to the second state S2, obtaining a time reference 22 (Block 310). The method may also comprise, while in the second state S2, storing the time reference 22 in memory 24 (Block 320).

The method as shown further comprises switching from the second state S2 to the first state S1. Then, after or as part of switching from the second state S2 to the first state S1, the method may comprise resuming track of time using the time reference 22 (Block 340).

In some embodiments, e.g., before switching to the second state S2, the method alternatively or additionally includes transmitting notification signaling (Block 350). The notification signaling may indicate that the wireless communication device 12 is or will be unreachable, that the wireless communication device 12 is or will be in a certain state S2, where the wireless communication device 12 is unreachable in the certain state S2, and/or a time interval for which the wireless communication device 12 will be unreachable.

In some embodiments, while in the second state S2, all hardware components 16H of the wireless communication equipment 16 are powered down and/or no timer T of the wireless communication equipment 16 is running.

In some embodiments, the memory 24 is memory of the wireless communication equipment 16.

In some embodiments, the memory 24 is memory of the wireless communication device 12.

In some embodiments, the method further comprises, after or as part of switching from the second state S2 to the first state S1, obtaining an updated time reference 32. In some embodiments, said resuming comprises resuming track of time using the time reference 22 stored in memory 24 while in the second state S2 and using the updated time reference 32. In some embodiments, said resuming comprises determining an amount of time that passed while in the second state S2 by comparing the updated time reference 32 to the time reference 22 stored in memory 24. In some embodiments, the method further comprises, while in the first state S1, keeping track of time using a timer T. In this case, the method further comprises, before or as part of switching from the first state S1 to the second state S2, capturing a state of the timer T. In this case, the method further comprises, while in the second state S2, storing in memory 24 also the captured state of the timer T. In some embodiments, said resuming comprises resuming keeping track of time using the timer T by updating the state of the timer T to account for the determined amount of time that passed while in the second state S2. In some embodiments, the captured state of the timer T includes a periodicity of the timer T and a value of the timer T. In some embodiments, the timer T tracks time for paging, discontinuous reception, public land mobile network search, tracking area update, or tracking area registration. In some embodiments, while in the first state S1, the wireless communication equipment 16 keeps track of time using the timer T as part of keeping track of when to execute a procedure in the first state S1. In some embodiments, while in the second state S2, the wireless communication equipment 16 does not keep track of when to execute the procedure. In some embodiments, resuming keeping track of time is performed as part of the wireless communication equipment 16 resuming keeping track of when to execute the procedure. In some embodiments, the procedure is a paging procedure, a discontinuous reception procedure, a public land mobile network search procedure, a tracking area update procedure, or a tracking area registration procedure. In some embodiments, resuming keeping track of when to execute the procedure comprises resuming keeping track of when to execute the procedure using the timer T, with the state of the timer T updated to account for the determined amount of time that passed while in the second state S2. In some embodiments, the method further comprises, after switching from the second state S2 to the first state S1 and after the state of the timer T has been updated to account for the determined amount of time that passed while in the second state S2, executing the procedure when the timer T expires. In some embodiments, the method further comprises, after switching from the second state S2 to the first state S1 and after the state of the timer T has been updated to account for the determined amount of time that passed while in the second state S2, determining that the amount of time that passed while in the second state S2 is greater than an amount of time that remained on the timer T before switching to the second state S2. In this case, the method further comprises, responsive to said determining, executing the procedure. In some embodiments, the method further comprises, before or as part of switching from the first state S1 to the second state S2, stopping the timer T. In some embodiments, the captured state of the timer T includes a value of the timer T when the timer T is stopped, and said resuming comprises offsetting a value of the timer T by the determined amount of time that passed while in the second state S2 and re-starting the timer T with the adjusted value. In some embodiments, the timer T is an idle state timer configured to run in an idle state. In some embodiments, the updated time reference 32 is a timestamp. In some embodiments, the updated time reference 32 is an absolute time reference. In some embodiments, obtaining the updated time reference 32 comprises receiving the updated time reference 32 from a network node 14 in the wireless communication network 10. In some embodiments, the updated time reference 32 is received in system information broadcast from the network node 14. In some embodiments, obtaining the updated time reference 32 comprises receiving the updated time reference 32 as included in or indicated by a signal that prompts said switching from the second state S2 to the first state S1.

In some embodiments, obtaining the time reference 22 comprises receiving the time reference 22 from a network node 14 in the wireless communication network 10.

In some embodiments, the time reference 22 is a timestamp.

In some embodiments, the time reference 22 is an absolute time reference.

In some embodiments, the method further comprises, while in the first state S1, keeping track of time using a timer T, and, before or as part of switching from the first state S1 to the second state S2, stopping the timer T. In some embodiments, the time reference 22 obtained and stored in memory 24 is a value of the timer T when the timer T is stopped. In some embodiments, said resuming comprises resuming keeping track of time using the timer T by re-starting the timer T with the value stored in memory 24.

In some embodiments, the first state S1 is an idle state. In some embodiments, the idle state is a Radio Resource Control, RRC, idle state. In other embodiments, the first state S1 a power-saving mode (PSM) or a Mobile Initiated Communication Only, MICO, mode.

In some embodiments, the second state S2 is a zero power idle state.

In some embodiments, the wireless communication device 12 comprises control equipment 18 configured to control said switching from the second state S2 to the first state S1. In some embodiments, the control equipment 18 monitors an amount of energy harvested while in the second state S2 and controls switching from the second state S2 to the first state S1 to occur when the amount of energy harvested reaches a threshold amount. In some embodiments, the amount of energy harvested comprises an amount of energy harvested by a photo-volvatic cell 20 connected to a battery 12B. In some embodiments, the control equipment 18 monitors an amount of time passed while in the second state S2 and controls switching from the second state S2 to the first state S1 to occur when the amount of time passed reaches a threshold amount.

In some embodiments, the wireless communication equipment 16 comprises a wireless module. In some embodiments, the wireless module comprises baseband processing circuitry and/or radio frequency front-end circuitry.

In some embodiments, the method further comprises, before or as part of switching from the first state S1 to the second state S2, transmitting, to a network node 14 in the wireless communication network 10, signaling. In some embodiments, the signaling indicates that the wireless communication device 12 is or will be unreachable. In other embodiments, the signaling alternatively or additionally indicates that the wireless communication device 12 is or will be in the second state S2. In this case, the wireless communication device 12 is unreachable in the second state S2. In yet other embodiments, the signaling alternatively or additionally indicates a time interval for which the wireless communication device 12 will be unreachable.

Additional aspects of the method in FIG. 3 are enumerated in Embodiment Groups A and B herein.

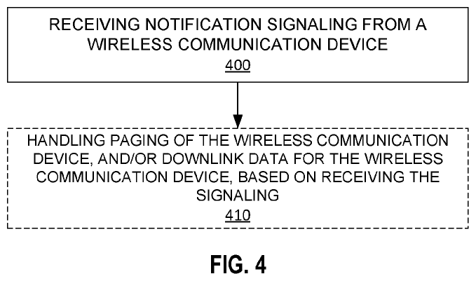

FIG. 4 depicts a method performed by a network node 14 in accordance with other particular embodiments. The method includes receiving notification signaling from a wireless communication device 12 (Block 400). The notification signaling may indicate that the wireless communication device 12 is or will be unreachable, that the wireless communication device 12 is or will be in a certain state S2, where the wireless communication device 12 is unreachable in the certain state S2, and/or a time interval for which the wireless communication device 12 will be unreachable.

In some embodiments, the method also comprises handling paging of the wireless communication device 12, and/or downlink data for the wireless communication device 12, based on receiving the signaling (Block 410).

In some embodiments, wireless communication equipment 16 of the wireless communication device 12 does not keep track of time in the certain state S2.

In some embodiments, the wireless communication device 12 includes wireless communication equipment 16. In some embodiments, all hardware components 16H of the wireless communication equipment 16 are powered down while in the certain state S2. In some embodiments, the wireless communication equipment 16 comprises a wireless module.

In some embodiments, the certain state S2 is a zero power idle state.

In some embodiments, the method also comprises handling paging of the wireless communication device 12, and/or downlink data for the wireless communication device 12, based on receiving the signaling. In some embodiments, said handling comprises suspending paging of the wireless communication device 12 based on the received signaling. In some embodiments, the method also comprises, after said suspending, resuming paging of the wireless communication device 12 when the wireless communication device 12 becomes reachable again. In some embodiments, said handling comprises buffering downlink data for the wireless communication device 12 based on the received signaling. In some embodiments, the method also comprises, after said buffering, transmitting the buffered downlink data to the wireless communication device 12 when the wireless communication device 12 becomes reachable again. In some embodiments, said handling comprises discarding downlink data for the wireless communication device 12 based on the received signaling. In some embodiments, said handling comprises, based on the received signaling, notifying a sender of the downlink data that the wireless communication device 12 is unreachable.

In some embodiments, the wireless module comprises baseband processing circuitry and/or radio frequency front-end circuitry.

Additional aspects of the method in FIG. 4 are enumerated in Embodiment Group X herein.

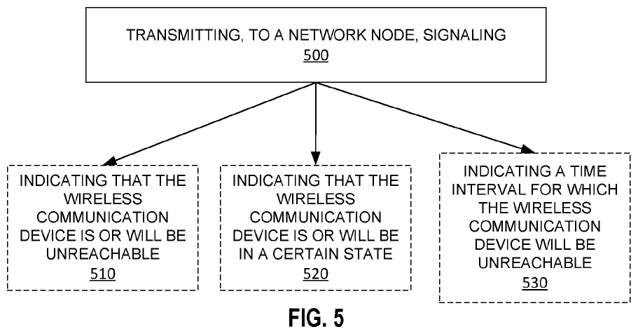

FIG. 5 depicts a method performed by a wireless communication device 12 configured for use in a wireless communication network 10 in accordance with other particular embodiments. The method includes transmitting, to a network node 14, signaling (Block 500). In some embodiments, the signaling indicates that the wireless communication device 12 is or will be unreachable (Block 510). In other embodiments, the signaling alternatively or additionally indicates that the wireless communication device 12 is or will be in a certain state S2 (Block 520). In this case, the wireless communication device 12 is unreachable in the certain state S2. In yet other embodiments, the signaling alternatively or additionally indicates a time interval for which the wireless communication device 12 will be unreachable (Block 530).

In some embodiments, wireless communication equipment 16 of the wireless communication device 12 does not keep track of time in the certain state S2.

In some embodiments, the wireless communication device 12 includes wireless communication equipment 16. In some embodiments, all hardware components 16H of the wireless communication equipment 16 are powered down while in the certain state S2. In some embodiments, the wireless communication equipment 16 comprises a wireless module. In some embodiments, the wireless module comprises baseband processing circuitry and/or radio frequency front-end circuitry.

In some embodiments, the certain state S2 is a zero power idle state.

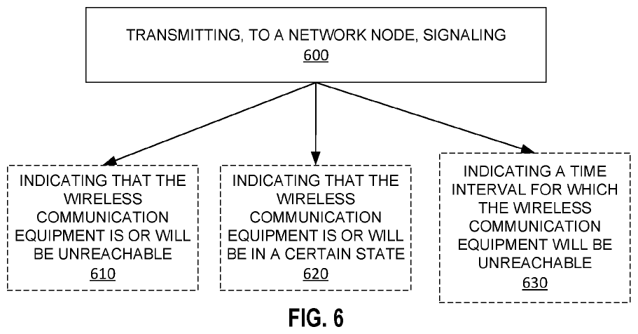

FIG. 6 depicts a method performed by wireless communication equipment 16 of a wireless communication device 12 configured for use in a wireless communication network 10 in accordance with other particular embodiments. The method includes transmitting, to a network node 14, signaling (Block 600). In some embodiments, the signaling indicates that the wireless communication equipment 16 is or will be unreachable (Block 610). In other embodiments, the signaling alternatively or additionally indicates that the wireless communication equipment 16 is or will be in a certain state S2 (Block 620). In this case, the wireless communication equipment 16 is unreachable in the certain state S2. In yet other embodiments, the signaling alternatively or additionally indicates a time interval for which the wireless communication equipment 16 will be unreachable (Block 630).

In some embodiments, wireless communication equipment 16 of the wireless communication device 12 does not keep track of time in the certain state S2.

In some embodiments, the wireless communication device 12 includes wireless communication equipment 16. In some embodiments, all hardware components 16H of the wireless communication equipment 16 are powered down while in the certain state S2. In some embodiments, the wireless communication equipment 16 comprises a wireless module. In some embodiments, the wireless module comprises baseband processing circuitry and/or radio frequency front-end circuitry.

In some embodiments, the certain state S2 is a zero power idle state.

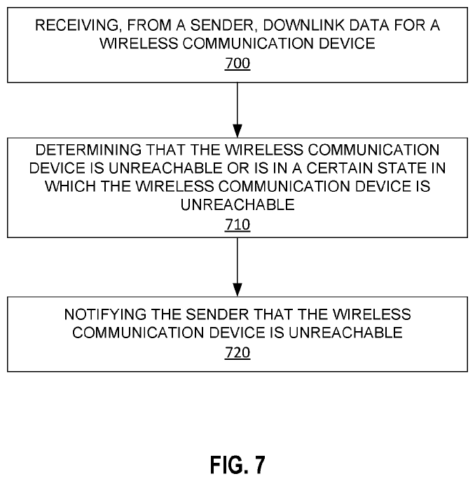

FIG. 7 depicts a method performed by a network node 14 of a wireless communication network 10 in accordance with other particular embodiments. The method includes receiving, from a sender, downlink data for a wireless communication device 12 (Block 700). The method also includes determining that the wireless communication device 12 is unreachable or is in a certain state S2 in which the wireless communication device 12 is unreachable (Block 710). The method also includes notifying the sender that the wireless communication device 12 is unreachable (Block 720).

Embodiments herein also include corresponding apparatuses. Embodiments herein for instance include a wireless communication device 12 configured to perform any of the steps of any of the embodiments described above for the wireless communication device 12.

Embodiments also include a wireless communication device 12 comprising processing circuitry and power supply circuitry. The processing circuitry is configured to perform any of the steps of any of the embodiments described above for the wireless communication device 12. The power supply circuitry is configured to supply power to the wireless communication device 12.

Embodiments further include a wireless communication device 12 comprising processing circuitry. The processing circuitry is configured to perform any of the steps of any of the embodiments described above for the wireless communication device 12. In some embodiments, the wireless communication device 12 further comprises communication circuitry.

Embodiments further include a wireless communication device 12 comprising processing circuitry and memory. The memory contains instructions executable by the processing circuitry whereby the wireless communication device 12 is configured to perform any of the steps of any of the embodiments described above for the wireless communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include wireless communication equipment 16 configured to perform any of the steps of any of the embodiments described above for the wireless communication equipment 16.

Embodiments also include wireless communication equipment 16 comprising processing circuitry and power supply circuitry. The processing circuitry is configured to perform any of the steps of any of the embodiments described above for the wireless communication equipment 16. The power supply circuitry is configured to supply power to the wireless communication equipment 16.

Embodiments further include wireless communication equipment 16 comprising processing circuitry. The processing circuitry is configured to perform any of the steps of any of the embodiments described above for the wireless communication equipment 16. In some embodiments, the wireless communication equipment 16 further comprises communication circuitry.

Embodiments further include wireless communication equipment 16 comprising processing circuitry and memory. The memory contains instructions executable by the processing circuitry whereby the wireless communication equipment 16 is configured to perform any of the steps of any of the embodiments described above for the wireless communication equipment 16.

Embodiments herein also include a network node 14 configured to perform any of the steps of any of the embodiments described above for the network node 14.

Embodiments also include a network node 14 comprising processing circuitry and power supply circuitry. The processing circuitry is configured to perform any of the steps of any of the embodiments described above for the network node 14. The power supply circuitry is configured to supply power to the network node 14.

Embodiments further include a network node 14 comprising processing circuitry. The processing circuitry is configured to perform any of the steps of any of the embodiments described above for the network node 14. In some embodiments, the network node 14 further comprises communication circuitry.

Embodiments further include a network node 14 comprising processing circuitry and memory. The memory contains instructions executable by the processing circuitry whereby the network node 14 is configured to perform any of the steps of any of the embodiments described above for the network node 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

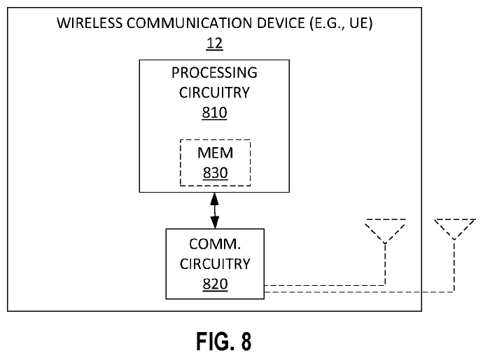

FIG. 8 for example illustrates a wireless communication device 12 as implemented in accordance with one or more embodiments. As shown, the wireless communication device 12 includes processing circuitry 810 and communication circuitry 820. The communication circuitry 820 (e.g., radio circuitry) is configured to transmit and/or receive information to and/or from one or more other nodes, e.g., via any communication technology. Such communication may occur via one or more antennas that are either internal or external to the wireless device 800. The processing circuitry 810 is configured to perform processing described above, e.g., in FIG. 3, FIG. 5, and/or FIG. 6, such as by executing instructions stored in memory 830. The processing circuitry 810 in this regard may implement certain functional means, units, or modules.

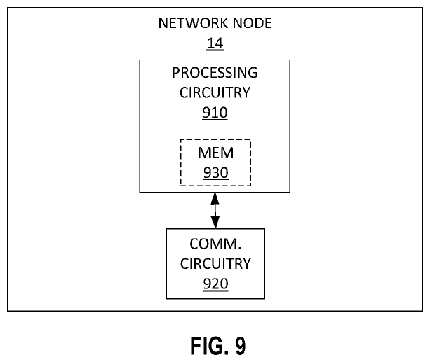

FIG. 9 illustrates a network node 14 as implemented in accordance with one or more embodiments. As shown, the network node 14 includes processing circuitry 910 and communication circuitry 920. The communication circuitry 920 is configured to transmit and/or receive information to and/or from one or more other nodes, e.g., via any communication technology. The processing circuitry 910 is configured to perform processing described above, e.g., in FIG. 4 and/or FIG. 7, such as by executing instructions stored in memory 930. The processing circuitry 910 in this regard may implement certain functional means, units, or modules.

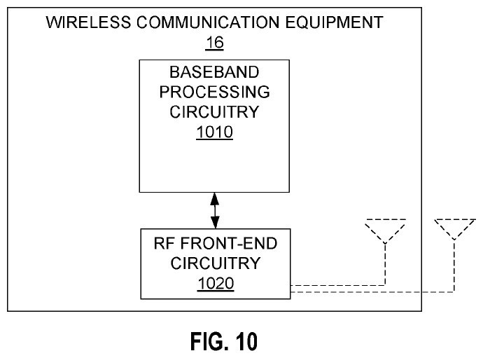

FIG. 10 illustrates wireless communication equipment 16 as implemented in accordance with one or more embodiments. The wireless communication equipment 16 may for example be or include a wireless module, e.g., configured to perform wireless transmission and reception as specified by the 3^{rd} Generation Partnership Project (3GPP). The wireless communication equipment 16 may, for instance, include baseband processing circuitry 1010 and/or radio frequency (RF) front-end circuitry 1020. The baseband processing circuitry 1010 may contain hardware components configured to perform baseband signal processing, e.g., including analog to digital conversion, digital to analog conversion, gain adjustment, modulation/demodulation, channel encoding/decoding, etc. The radio frequency (RF) front-end circuitry 1020 may contain hardware components configured to convert received RF signals to baseband signals and convert baseband signals to RF signals for transmission, e.g., via one or more antennas. The wireless communication equipment 16 may be configured to perform processing described above, e.g., in FIG. 3, such as by executing instructions stored in memory.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3^{rd} Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

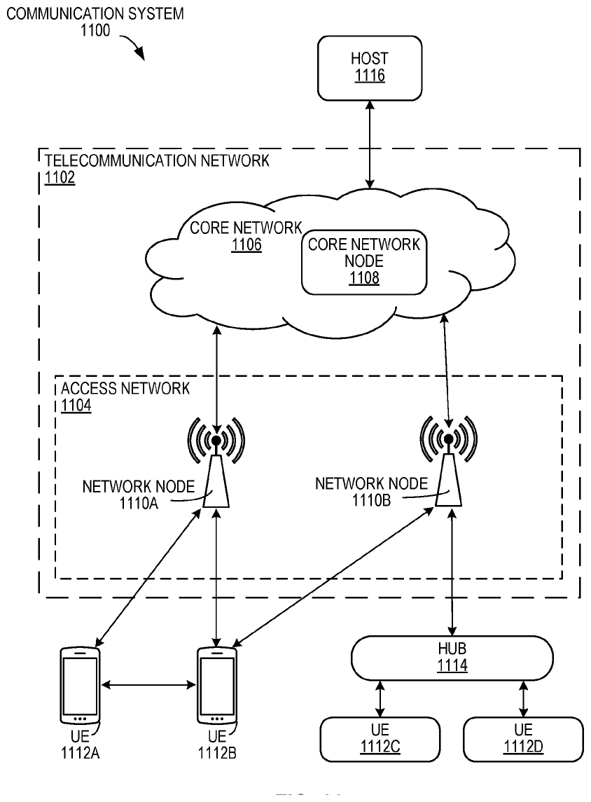

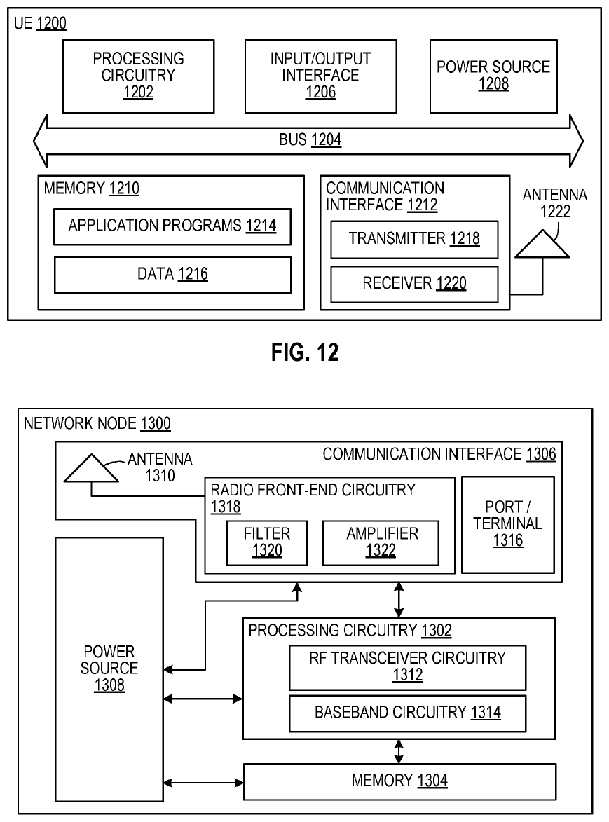

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

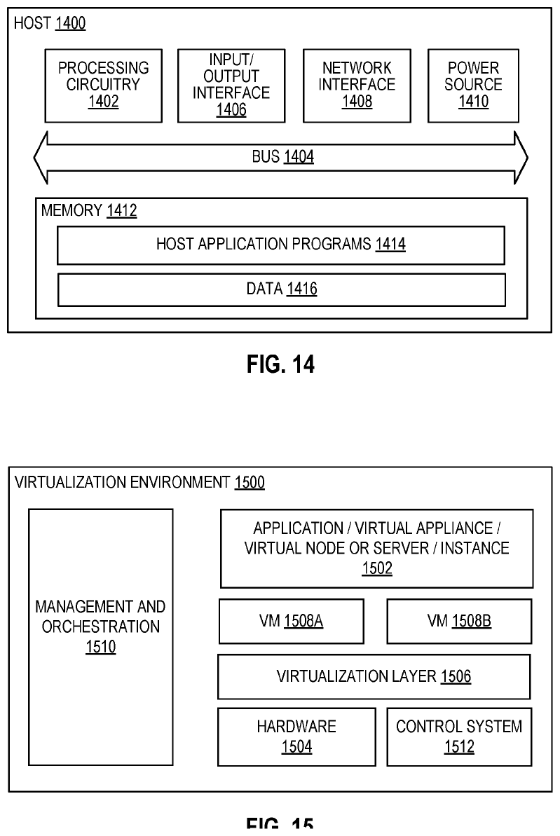

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless communication device configured for use in a wireless communication network, the method comprising:
   switching from a first state in which wireless communication equipment of the wireless communication device keeps track of time to a second state in which the wireless communication equipment does not keep track of time;
   before or as part of switching from the first state to the second state, obtaining a time reference;
   while in the second state, storing the time reference in memory;
   switching from the second state to the first state; and
   after or as part of switching from the second state to the first state, resuming track of time using the time reference.
A2. The method of embodiment A1, wherein, while in the second state, all hardware components of the wireless communication equipment are powered down and/or no timer of the wireless communication equipment is running.
A3. The method of any of embodiments A1-A2, wherein the memory is memory of the wireless communication equipment.
A4. The method of any of embodiments A1-A2, wherein the memory is memory of the wireless communication device.
A5. The method of any of embodiments A1-A4, further comprising, after or as part of switching from the second state to the first state, obtaining an updated time reference, and wherein said resuming comprises resuming track of time using the time reference stored in memory while in the second state and using the updated time reference.
A6. The method of embodiment A5, wherein said resuming comprises determining an amount of time that passed while in the second state by comparing the updated time reference to the time reference stored in memory.
A7. The method of embodiment A6, further comprising:
   while in the first state, keeping track of time using a timer;
   before or as part of switching from the first state to the second state, capturing a state of the timer;
   while in the second state, storing in memory also the captured state of the timer;
   wherein said resuming comprises resuming keeping track of time using the timer by updating the state of the timer to account for the determined amount of time that passed while in the second state.
A8. The method of embodiment A7, wherein the captured state of the timer includes a periodicity of the timer and a value of the timer.
A9. The method of any of embodiments A7-A8, wherein the timer tracks time for paging, discontinuous reception, public land mobile network search, tracking area update, or tracking area registration.
A10. The method of any of embodiments A7-A9, wherein, while in the first state, the wireless communication equipment keeps track of time using the timer as part of keeping track of when to execute a procedure in the first state, wherein, while in the second state, the wireless communication equipment does not keep track of when to execute the procedure, and wherein resuming keeping track of time is performed as part of the wireless communication equipment resuming keeping track of when to execute the procedure.
A11. The method of embodiment A10, wherein the procedure is a paging procedure, a discontinuous reception procedure, a public land mobile network search procedure, a tracking area update procedure, or a tracking area registration procedure.
A12. The method of any of embodiments A10-A11, wherein resuming keeping track of when to execute the procedure comprises resuming keeping track of when to execute the procedure using the timer, with the state of the timer updated to account for the determined amount of time that passed while in the second state.
A13. The method of embodiment A12, further comprising, after switching from the second state to the first state and after the state of the timer has been updated to account for the determined amount of time that passed while in the second state, executing the procedure when the timer expires.
A14. The method of embodiment A12, further comprising, after switching from the second state to the first state and after the state of the timer has been updated to account for the determined amount of time that passed while in the second state:
   determining that the amount of time that passed while in the second state is greater than an amount of time that remained on the timer before switching to the second state; and
   responsive to said determining, executing the procedure.
A15. The method of any of embodiments A7-A14, further comprising, before or as part of switching from the first state to the second state, stopping the timer, wherein the captured state of the timer includes a value of the timer when the timer is stopped, and wherein said resuming comprises offsetting a value of the timer by the determined amount of time that passed while in the second state and re-starting the timer with the adjusted value.
A16. The method of any of embodiments A7-A15, wherein the timer is an idle state timer configured to run in an idle state.
A17. The method of any of embodiments A5-A16, wherein the updated time reference is a timestamp.
A18. The method of any of embodiments A5-A17, wherein the updated time reference is an absolute time reference.
A19. The method of any of embodiments A5-A18, wherein obtaining the updated time reference comprises receiving the updated time reference from a network node in the wireless communication network.
A20. The method of embodiment A19, wherein the updated time reference is received in system information broadcast from the network node.
A21. The method of any of embodiments A5-A20, wherein obtaining the updated time reference comprises receiving the updated time reference as included in or indicated by a signal that prompts said switching from the second state to the first state.
A22. The method of any of embodiments A1-A21, wherein obtaining the time reference comprises receiving the time reference from a network node in the wireless communication network.
A23. The method of any of embodiments A1-A22, wherein the time reference is a timestamp.
A24. The method of any of embodiments A1-A23, wherein the time reference is an absolute time reference.
A25. The method of any of embodiments A1-A4, further comprising, while in the first state, keeping track of time using a timer, and, before or as part of switching from the first state to the second state, stopping the timer, wherein the time reference obtained and stored in memory is a value of the timer when the timer is stopped, wherein said resuming comprises resuming keeping track of time using the timer by re-starting the timer with the value stored in memory.
A26. The method of any of embodiments A1-A25, wherein the first state is an idle state.
A27. The method of embodiment A26, wherein the idle state is a Radio Resource Control, RRC, idle state.
A28. The method of any of embodiments A1-A27, wherein the second state is a zero power idle state.
A29. The method of any of embodiments A1-A28, wherein the wireless communication device comprises control equipment configured to control said switching from the second state to the first state.
A30. The method of embodiment A29, wherein the control equipment monitors an amount of energy harvested while in the second state and controls switching from the second state to the first state to occur when the amount of energy harvested reaches a threshold amount.
A31. The method of embodiment A30, wherein the amount of energy harvested comprises an amount of energy harvested by a photo-volvatic cell connected to a battery.
A32. The method of embodiment A29, wherein the control equipment monitors an amount of time passed while in the second state and controls switching from the second state to the first state to occur when the amount of time passed reaches a threshold amount.
A33. The method of any of embodiments A1-A32, wherein the wireless communication equipment comprises a wireless module.
A34. The method of embodiment A33, wherein the wireless module comprises baseband processing circuitry and/or radio frequency front-end circuitry.
A35. The method of any of embodiments A1-A34, further comprising, before or as part of switching from the first state to the second state, transmitting, to a network node in the wireless communication network, signaling indicating:
   that the wireless communication device is or will be unreachable;
   that the wireless communication device is or will be in the second state, wherein the wireless communication device is unreachable in the second state; and/or
   a time interval for which the wireless communication device will be unreachable.
AA1. A method performed by a wireless communication device configured for use in a wireless communication network, the method comprising:
   transmitting, to a network node, signaling indicating:
      that the wireless communication device is or will be unreachable;
      that the wireless communication device is or will be in a certain state, wherein the wireless communication device is unreachable in the certain state; and/or
      a time interval for which the wireless communication device will be unreachable.
AA2. The method of embodiment AA1, wherein wireless communication equipment of the wireless communication device does not keep track of time in the certain state.
AA3. The method of any of embodiments AA1-AA2, wherein the wireless communication device includes wireless communication equipment, wherein all hardware components of the wireless communication equipment are powered down while in the certain state.
AA4. The method of any of embodiments AA2-AA3, wherein the wireless communication equipment comprises a wireless module.
AA5. The method of embodiment AA4, wherein the wireless module comprises baseband processing circuitry and/or radio frequency front-end circuitry.
AA6. The method of any of embodiments AA1-AA5, wherein the certain state is a zero power idle state.
AA. The method of any of the previous embodiments, further comprising:
   providing user data; and
   forwarding the user data to a host via the transmission to the network node.

### Group B Embodiments

B1. A method performed by wireless communication equipment of a wireless communication device configured for use in a wireless communication network, the method comprising:
   switching from a first state in which the wireless communication equipment keeps track of time to a second state in which the wireless communication equipment does not keep track of time;
   before or as part of switching from the first state to the second state, obtaining a time reference;
   while operating in the second state, storing the time reference in memory;
   switching from the second state to the first state; and
   after or as part of switching from the second state to the first state, resuming track of time using the time reference.
B2. The method of embodiment B1, wherein, while in the second state, all hardware components of the wireless communication equipment are powered down and/or no timer of the wireless communication equipment is running.
B3. The method of any of embodiments B1-B2, wherein the memory is memory of the wireless communication equipment.
B4 Reserved.
B5. The method of any of embodiments B1-B4, further comprising, after or as part of switching from the second state to the first state, obtaining an updated time reference, and wherein said resuming comprises resuming track of time using the time reference stored in memory while in the second state and using the updated time reference.
B6. The method of embodiment B5, wherein said resuming comprises determining an amount of time that passed while in the second state by comparing the updated time reference to the time reference stored in memory.
B7. The method of embodiment B6, further comprising:
   while in the first state, keeping track of time using a timer;
   before or as part of switching from the first state to the second state, capturing a state of the timer;
   while in the second state, storing in memory also the captured state of the timer;
   wherein said resuming comprises resuming keeping track of time using the timer by updating the state of the timer to account for the determined amount of time that passed while in the second state.
B8. The method of embodiment B7, wherein the captured state of the timer includes a periodicity of the timer and a value of the timer.
B9. The method of any of embodiments B7-B8, wherein the timer tracks time for paging, discontinuous reception, public land mobile network search, tracking area update, or tracking area registration.
B10. The method of any of embodiments B7-B9, wherein, while in the first state, the wireless communication equipment keeps track of time using the timer as part of keeping track of when to execute a procedure in the first state, wherein, while in the second state, the wireless communication equipment does not keep track of when to execute the procedure, and wherein resuming keeping track of time is performed as part of the wireless communication equipment resuming keeping track of when to execute the procedure.
B11. The method of embodiment B10, wherein the procedure is a paging procedure, a discontinuous reception procedure, a public land mobile network search procedure, a tracking area update procedure, or a tracking area registration procedure.
B12. The method of any of embodiments B10-B11, wherein resuming keeping track of when to execute the procedure comprises resuming keeping track of when to execute the procedure using the timer, with the state of the timer updated to account for the determined amount of time that passed while in the second state.
B13. The method of embodiment B12, further comprising, after switching from the second state to the first state and after the state of the timer has been updated to account for the determined amount of time that passed while in the second state, executing the procedure when the timer expires.
B14. The method of embodiment B12, further comprising, after switching from the second state to the first state and after the state of the timer has been updated to account for the determined amount of time that passed while in the second state:
   determining that the amount of time that passed while in the second state is greater than an amount of time that remained on the timer before switching to the second state; and
   responsive to said determining, executing the procedure.
B15. The method of any of embodiments B7-B14, further comprising, before or as part of switching from the first state to the second state, stopping the timer, wherein the captured state of the timer includes a value of the timer when the timer is stopped, and wherein said resuming comprises offsetting a value of the timer by the determined amount of time that passed while in the second state and re-starting the timer with the adjusted value.
B16. The method of any of embodiments B7-B15, wherein the timer is an idle state timer configured to run in an idle state.
B17. The method of any of embodiments B5-B16, wherein the updated time reference is a timestamp.
B18. The method of any of embodiments B5-B17, wherein the updated time reference is an absolute time reference.
B19. The method of any of embodiments B5-B18, wherein obtaining the updated time reference comprises receiving the updated time reference from a network node in the wireless communication network.
B20. The method of embodiment B19, wherein the updated time reference is received in system information broadcast from the network node.
B21. The method of any of embodiments B5-B20, wherein obtaining the updated time reference comprises receiving the updated time reference as included in or indicated by a signal that prompts said switching from the second state to the first state.
B22. The method of any of embodiments B1-B21, wherein obtaining the time reference comprises receiving the time reference from a network node in the wireless communication network.
B23. The method of any of embodiments B1-B22, wherein the time reference is a timestamp.
B24. The method of any of embodiments B1-B23, wherein the time reference is an absolute time reference.
B25. The method of any of embodiments B1-B4, further comprising, while in the first state, keeping track of time using a timer, and, before or as part of switching from the first state to the second state, stopping the timer, wherein the time reference obtained and stored in memory is a value of the timer when the timer is stopped, wherein said resuming comprises resuming keeping track of time using the timer by re-starting the timer with the value stored in memory.
B26. The method of any of embodiments B1-B25, wherein the first state is an idle state.
B27. The method of embodiment B26, wherein the idle state is a Radio Resource Control, RRC, idle state.
B28. The method of any of embodiments B1-B27, wherein the second state is a zero power idle state.
B29. The method of any of embodiments B1-B28, wherein said switching from the second state to the first state is performed responsive to receiving, by the wireless communication equipment, a control signal from control equipment of the wireless communication device.
B30. The method of embodiment B29, wherein the control signal is received when an amount of energy harvested while in the second state reaches a threshold amount.
B31. The method of embodiment B30, wherein the amount of energy harvested comprises an amount of energy harvested by a photo-volvatic cell connected to a battery.
B32. The method of embodiment B29, wherein the control signal is received when the control equipment determines an amount of time passed in the second state reaches a threshold amount.
B33. The method of any of embodiments B1-B32, wherein the wireless communication equipment comprises a wireless module.
B34. The method of embodiment B33, wherein the wireless module comprises baseband processing circuitry and/or radio frequency front-end circuitry.
B35. The method of any of embodiments B1-B34, further comprising, before or as part of switching from the first state to the second state, transmitting, to a network node in the wireless communication network, signaling indicating:
   that the wireless communication device is or will be unreachable;
   that the wireless communication device is or will be in the second state, wherein the wireless communication device is unreachable in the second state; and/or
   a time interval for which the wireless communication device will be unreachable.
BB1. A method performed by wireless communication equipment of a wireless communication device configured for use in a wireless communication network, the method comprising:
   transmitting, to a network node, signaling indicating:
      that the wireless communication equipment is or will be unreachable;
      that the wireless communication equipment is or will be in a certain state, wherein the wireless communication equipment is unreachable in the certain state; and/or
      a time interval for which the wireless communication equipment will be unreachable.
BB2. The method of embodiment BB1, wherein wireless communication equipment of the wireless communication device does not keep track of time in the certain state.
BB3. The method of any of embodiments BB1-BB2, wherein the wireless communication device includes wireless communication equipment, wherein all hardware components of the wireless communication equipment are powered down while in the certain state.
BB4. The method of any of embodiments BB2-BB3, wherein the wireless communication equipment comprises a wireless module.
BB5. The method of embodiment BB4, wherein the wireless module comprises baseband processing circuitry and/or radio frequency front-end circuitry.
BB6. The method of any of embodiments BB1-BB5, wherein the certain state is a zero power idle state.
BB. The method of any of the previous embodiments, further comprising:
   obtaining user data; and
   forwarding the user data to a host or a user equipment.

### Group X Embodiments

X1. A method performed by a network node of a wireless communication network, the method comprising:
   receiving, from a wireless communication device, signaling indicating:
      that the wireless communication device is or will be unreachable;
      that the wireless communication device is or will be in a certain state, wherein the wireless communication device is unreachable in the certain state; and/or
      a time interval for which the wireless communication device will be unreachable.
X2. The method of embodiment X1, wherein wireless communication equipment of the wireless communication device does not keep track of time in the certain state.
X3. The method of any of embodiments X1-X2, wherein the wireless communication device includes wireless communication equipment, wherein all hardware components of the wireless communication equipment are powered down while in the certain state.
X4. The method of any of embodiments X2-X3, wherein the wireless communication equipment comprises a wireless module.
X5. The method of any of embodiments X1-X4, wherein the certain state is a zero power idle state.
X6. The method of any of embodiments X1-X5, further comprising handling paging of the wireless communication device, and/or downlink data for the wireless communication device, based on receiving the signaling.
X7. The method of embodiment X6, wherein said handling comprises suspending paging of the wireless communication device based on the received signaling.
X8. The method of embodiment X7, further comprising, after said suspending, resuming paging of the wireless communication device when the wireless communication device becomes reachable again.
X9. The method of any of embodiments X6-X8, wherein said handling comprises buffering downlink data for the wireless communication device based on the received signaling.
X10. The method of embodiment X9, further comprising, after said buffering, transmitting the buffered downlink data to the wireless communication device when the wireless communication device becomes reachable again.
X11. The method of any of embodiments X6-X8, wherein said handling comprises discarding downlink data for the wireless communication device based on the received signaling.
X12. The method of any of embodiments X6-X8, wherein said handling comprises, based on the received signaling, notifying a sender of the downlink data that the wireless communication device is unreachable.
X13. The method of embodiment X4, wherein the wireless module comprises baseband processing circuitry and/or radio frequency front-end circuitry.
XX1. A method performed by a network node of a wireless communication network, the method comprising:
   receiving, from a sender, downlink data for a wireless communication device;
   determining that the wireless communication device is unreachable or is in a certain state in which the wireless communication device is unreachable; and
   notifying the sender that the wireless communication device is unreachable.

### Group C Embodiments

C1. A wireless communication device configured to perform any of the steps of any of the Group A embodiments.
C2. A wireless communication device comprising processing circuitry configured to perform any of the steps of any of the Group A embodiments.
C3. A wireless communication device comprising:
   communication circuitry; and
   processing circuitry configured to perform any of the steps of any of the Group A embodiments.
C4. A wireless communication device comprising:
   processing circuitry configured to perform any of the steps of any of the Group A embodiments; and
   power supply circuitry configured to supply power to the wireless communication device.
C5. A wireless communication device comprising:
   processing circuitry and memory, the memory containing instructions executable by the processing circuitry whereby the wireless communication device is configured to perform any of the steps of any of the Group A embodiments.
C6. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C7. A computer program comprising instructions which, when executed by at least one processor of a wireless communication device, causes the wireless communication device to carry out the steps of any of the Group A embodiments.
C8. A carrier containing the computer program of embodiment C7, wherein the carrier is one of an electronic signal, optical signal, radio signal, or computer readable storage medium.
C9. A network node configured to perform any of the steps of any of the Group X embodiments.
C10. A network node comprising processing circuitry configured to perform any of the steps of any of the Group X embodiments.
C11. A network node comprising:
   communication circuitry; and
   processing circuitry configured to perform any of the steps of any of the Group X embodiments.
C12. A network node comprising:
   processing circuitry configured to perform any of the steps of any of the Group X embodiments;
   power supply circuitry configured to supply power to the network node.
C13. A network node comprising:
   processing circuitry and memory, the memory containing instructions executable by the processing circuitry whereby the network node is configured to perform any of the steps of any of the Group X embodiments.
C14. The network node of any of embodiments C9-C13, wherein the network node is a base station.
C15. A computer program comprising instructions which, when executed by at least one processor of a network node, causes the network node to carry out the steps of any of the Group X embodiments.
C16. The computer program of embodiment C14, wherein the network node is a base station.
C17. A carrier containing the computer program of any of embodiments C15-C16, wherein the carrier is one of an electronic signal, optical signal, radio signal, or computer readable storage medium.
C18. Wireless communication equipment configured for use in a wireless communication device, the wireless communication equipment configured to perform any of the steps of any of the Group B embodiments.
C19. Wireless communication equipment configured for use in a wireless communication device, the wireless communication equipment comprising processing circuitry configured to perform any of the steps of any of the Group B embodiments.
C20. Wireless communication equipment configured for use in a wireless communication device, the wireless communication equipment comprising:
   communication circuitry; and
   processing circuitry configured to perform any of the steps of any of the Group B embodiments.
C21. Wireless communication equipment configured for use in a wireless communication device, the wireless communication equipment comprising:
   processing circuitry configured to perform any of the steps of any of the Group B embodiments; and
   power supply circuitry configured to supply power to the wireless communication equipment.
C22. Wireless communication equipment configured for use in a wireless communication device, the wireless communication equipment comprising:
   processing circuitry and memory, the memory containing instructions executable by the processing circuitry whereby the wireless communication equipment is configured to perform any of the steps of any of the Group B embodiments.
C23. A user equipment (UE) comprising:
   an antenna configured to send and receive wireless signals;
   radio front-end circuitry connected to the antenna and to processing circuitry, and configured to condition signals communicated between the antenna and the processing circuitry;
   wireless communication equipment comprising processing circuitry configured to perform any of the steps of any of the Group B embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE
C24. A computer program comprising instructions which, when executed by at least one processor of a wireless communication equipment configured for use in a wireless communication device, causes the wireless communication equipment to carry out the steps of any of the Group B embodiments.
C25. A carrier containing the computer program of embodiment C24, wherein the carrier is one of an electronic signal, optical signal, radio signal, or computer readable storage medium.

### REFERENCES

1. TR 38.875 V17.0.0, “Study on support of reduced capability NR devices (Release 17)”, March 2021.
2. RWS-210314, New WID on enhanced RedCap, 3GPP RAN Rel-18 WS, June 2021

1.-33. (canceled)

34. A method performed by a wireless communication device configured for use in a wireless communication network, the method comprising:
switching from a first state in which wireless communication equipment of the wireless communication device keeps track of time to a second state in which the wireless communication equipment does not keep track of time;
before or as part of switching from the first state to the second state, obtaining a time reference;
while in the second state, storing the time reference in memory;
switching from the second state to the first state; and
after or as part of switching from the second state to the first state, resuming track of time using the time reference.

35. The method of claim 34, wherein, while in the second state, all hardware components of the wireless communication equipment are powered down and/or no timer of the wireless communication equipment is running.

36. The method of claim 34, further comprising:
while in the first state, keeping track of time using a timer;
before or as part of switching from the first state to the second state, capturing a state of the timer;
while in the second state, storing in memory also the captured state of the timer;
after or as part of switching from the second state to the first state, obtaining an updated time reference; and
determining an amount of time that passed while in the second state by comparing the updated time reference to the time reference stored in memory;
wherein said resuming comprises resuming keeping track of time using the timer by updating the state of the timer to account for the determined amount of time that passed while in the second state.

37. The method of claim 36, wherein the timer tracks time for paging, discontinuous reception, public land mobile network search, tracking area update, or tracking area registration.

38. The method of claim 36, wherein, while in the first state, the wireless communication equipment keeps track of time using the timer as part of keeping track of when to execute a procedure in the first state, wherein, while in the second state, the wireless communication equipment does not keep track of when to execute the procedure, and wherein resuming keeping track of time is performed as part of the wireless communication equipment resuming keeping track of when to execute the procedure, wherein resuming keeping track of when to execute the procedure comprises resuming keeping track of when to execute the procedure using the timer, with the state of the timer updated to account for the determined amount of time that passed while in the second state.

39. The method of claim 38, wherein the procedure is a paging procedure, a discontinuous reception procedure, a public land mobile network search procedure, a tracking area update procedure, or a tracking area registration procedure.

40. The method of claim 38, further comprising, after switching from the second state to the first state and after the state of the timer has been updated to account for the determined amount of time that passed while in the second state, executing the procedure:
when the timer expires; or
responsive to determining that the amount of time that passed while in the second state is greater than an amount of time that remained on the timer before switching to the second state.

41. The method of claim 36, further comprising, before or as part of switching from the first state to the second state, stopping the timer, wherein the captured state of the timer includes a value of the timer when the timer is stopped, and wherein said resuming comprises offsetting a value of the timer by the determined amount of time that passed while in the second state and re-starting the timer with the adjusted value.

42. The method of claim 36, wherein the timer is an idle state timer configured to run in an idle state.

43. The method of claim 34, wherein obtaining the time reference comprises receiving the time reference from a network node in the wireless communication network.

44. The method of claim 34, further comprising, while in the first state, keeping track of time using a timer, and, before or as part of switching from the first state to the second state, stopping the timer, wherein the time reference obtained and stored in memory is a value of the timer when the timer is stopped, wherein said resuming comprises resuming keeping track of time using the timer by re-starting the timer with the value stored in memory.

45. The method of claim 34, wherein the first state is a Radio Resource Control (RRC) idle state, a power-saving mode, or a Mobile Initiated Communication Only (MICO) mode.

46. The method of claim 34, wherein the second state is a zero power idle state.

47. The method of claim 34, wherein the wireless communication device comprises control equipment configured to control said switching from the second state to the first state, wherein the control equipment either:
monitors an amount of energy harvested while in the second state and controls switching from the second state to the first state to occur when the amount of energy harvested reaches a threshold amount; or
monitors an amount of time passed while in the second state and controls switching from the second state to the first state to occur when the amount of time passed reaches a threshold amount.

48. A method performed by a network node of a wireless communication network, the method comprising:
receiving, from a wireless communication device, signaling indicating:
that the wireless communication device is or will be unreachable; and/or
that the wireless communication device is or will be in a certain state, wherein the wireless communication device is unreachable in the certain state; and/or
a time interval for which the wireless communication device will be unreachable.

49. The method of claim 48, wherein the signaling indicates that the wireless communication device is or will be in the certain state, wherein the certain state is a zero power idle state.

50. The method of claim 48, further comprising handling paging of the wireless communication device, and/or downlink data for the wireless communication device, based on receiving the signaling.

51. The method of claim 50, wherein said handling comprises, based on the received signaling:
suspending paging of the wireless communication device; or
buffering downlink data for the wireless communication device; or
discarding downlink data for the wireless communication device; or
notifying a sender of the downlink data that the wireless communication device is unreachable.

52. A wireless communication device configured for use in a wireless communication network, the wireless communication device comprising wireless communication equipment and control equipment whereby the wireless communication device is configured to:
switch from a first state in which the wireless communication equipment keeps track of time to a second state in which the wireless communication equipment does not keep track of time;
before or as part of switching from the first state to the second state, obtain a time reference;
while in the second state, store the time reference in memory;
switch from the second state to the first state; and
after or as part of switching from the second state to the first state, resume track of time using the time reference.

53. A network node of a wireless communication network, the network node comprising:
communication circuitry; and
processing circuitry configured to receive, from a wireless communication device, via the communication circuitry, signaling indicating:
that the wireless communication device is or will be unreachable; and/or
that the wireless communication device is or will be in a certain state, wherein the wireless communication device is unreachable in the certain state; and/or
a time interval for which the wireless communication device will be unreachable.
